(19) United States
(12) Patent Application Publication
(10) Pub. No.: US 2018/0155470 A1
(43) Pub. Date: Jun. 7, 2018

(54) POLYMERIZATION OF ALPHA OLEFINS

(71) Applicant: Lion Copolymer Geismar, LLC, Geismar, LA (US)

(72) Inventors: Willie Burton, Geismar, LA (US); Thomas Toups, Geismar, LA (US)

(21) Appl. No.: 15/368,139

(22) Filed: Dec. 2, 2016

(51) Int. Cl. C08F 110/14

(52) U.S. Cl. CPC C08F 110/14; C08F 2420/01

(57) ABSTRACT

Herein discussed is a method of producing a polyolefin blend, comprising providing a catalyst system comprising a first catalyst, a second catalyst, a first co-catalyst, a second co-catalyst, and a third co-catalyst; polymerizing at least one monomer in a single step; obtaining the polyolefin blend having a Kinematic viscosity (Kv) of 6 to 1000 cSt at 100 degrees C., wherein the Kv is adjusted by varying the ratio of the first catalyst to the second catalyst without mixing separately-synthesized polymers.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

### Field of the Invention

This disclosure relates generally to the production of poly-alpha-olefins. More particularly, this disclosure relates to the production of custom poly-alpha-olefin blends.

### Background of Invention

A polyolefin is any of a class of polymers produced from a simple olefin (also called an alkene with the general formula CₙH₂) as a monomer. Among commonly used polyolefins are poly-alpha-olefin (or poly-α-olefin or polyalphaolefin or PAO), a polymer made by polymerizing an alpha-olefin. An alpha-olefin (or α-olefin) is an alkene where the carbon-carbon double bond starts at the α-carbon atom, i.e. the double bond is between the #1 and #2 carbons in the molecule.

Poly-alpha-olefins employed in many lubrication applications are products of blending two or more poly-alpha-olefins having different Kinematic viscosities (Kv) The blending process may be complex and time consuming. As such, there is an interest and need to develop new methods and systems to produce custom polyolefin blends.

### SUMMARY

Herein discussed is a method of producing a poly-alpha-olefin blend, comprising providing a catalyst system comprising a first catalyst, a second catalyst, a first co-catalyst, a second co-catalyst, and a third co-catalyst; polymerizing at least one monomer in a single step; obtaining the poly-alpha-olefin blend having a Kinematic viscosity (Kv) of 6.0 to 1000 cSt at 100° C., wherein the Kv is adjusted by varying the ratio of the first catalyst to the second catalyst without mixing separately-synthesized polymers.

In an embodiment, the monomer does not contain ethylene, propylene, butene, or pentene. In an embodiment, the produced poly-alpha-olefin is a homopolymer. In an embodiment, the produced poly-alpha-olefin is a copolymer. In an embodiment, the instant method comprises no second oligomerization step and no use of oligomerization catalyst. In an embodiment, no solvent is used in the polymerization step.

In an embodiment, the first catalyst comprises, but not limited to ethylenebis(indenyl) zirconium dichloride. In an embodiment, the second catalyst comprises, but not limited to dimethylsilylbis(tetrahydro indenyl) zirconium dichloride. In an embodiment, the first co-catalyst comprises N,N-dimethylaniliniumtetrakis(pentafluorophenyl) borate. In an embodiment, the second co-catalyst comprises methylaluminoxane. In an embodiment, the third co-catalyst comprises diisobutylaluminum hydride or triisobutylaluminum.

In an embodiment, the weight percentage of the first catalyst based on the total weight of the first and second catalysts is in the range of from 0.01 to 100 wt %. In an embodiment, the molar ratios of the first catalyst to each of the co-catalysts based on the active metal of the first catalyst are not varied. In other embodiments, these ratios are changed.

In an embodiment, the method comprises isolating the poly-olefin blend. In an embodiment, the isolating comprises diluting with a solvent, washing with an acid, filtering, removing the solvent and unreacted monomer under vacuum, or combinations thereof.

Also disclosed herein is a catalyst system, comprising a first catalyst, a second catalyst, a first co-catalyst, a second co-catalyst, and a third co-catalyst, wherein molar ratios of the first catalyst to each of the co-catalysts based on the active metal of the first catalyst are not varied.

In an embodiment, the catalyst system is capable of producing a custom poly-alpha-olefin blend in a single polymerization step, wherein the custom poly-alpha-olefin blend has a Kinematic viscosity (Kv) adjusted by varying the ratio of the first catalyst to the second catalyst without mixing separately-synthesized polymers. In an embodiment, the weight percentage of the first catalyst based on the total weight of the first and second catalysts is in the range of from 0 to 100 wt %.

In an embodiment, the catalyst system comprises a metallocene catalyst of racemic structure, not of meso structure. In an embodiment, the catalyst system comprises no solid support for the co-catalysts.

In various embodiments, the polymer blend produced by the disclosed method or the disclosed catalyst system can produce a wide range of Kinematic viscosities (Kv), for example, in the range of 6-1000 centistokes (cSt) at 100° C.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIGS. 1 and 2 illustrate PAO reactor blends produced by using a mixed catalyst system, according to embodiments of this disclosure.

### DETAILED DESCRIPTION

Poly-alpha-olefins employed in many lubrication applications are products of blending two or more poly-alpha-olefins having different Kinematic viscosities (Kv). This disclosure discusses an advantageous process and catalyst system to produce custom polyolefin blends (custom blends of polyolefins or polyalphaolefins) for lubrication formulators to purchase, thereby eliminating the initial formulation step.

The catalyst system of this disclosure allows production of custom poly-alpha-olefin blends during the polymerization process. In various embodiments, such a catalyst system is prepared by selecting two catalysts with similar reactivities toward the olefin, and capable of producing poly-alpha-olefins having different Kinematic viscosities. The catalysts are blended in ratios to produce the properties desired in the physically blended poly-alpha-olefins. For example, a catalyst capable of producing liquid poly-alpha-olefins having very low Kv is mixed with a catalyst capable of producing poly-alpha-olefin with high Kv to yield a polyolefin blend with Kv between the two. In various embodiment, the mix ratio of the two catalysts is adjusted to produce a broad spectrum of custom blends as required by the formulators.

In an embodiment, a catalyst system is prepared by mixing a 1:1 mole ratio of ethylenebis(indenyl) zirconium dichloride (Axion Zr 9036 from Chemtura Corp.) and dimethylsilylbis(1-tetrahydroindenyl) zirconium dichloride (Axion Zr 9033 from Chemtura Corp.), which produce high and low viscosity poly-alpha-olefins respectively. To this dry mixture is added a specified amount of a first co-catalyst borate salt, such as N,N-Dimethylaniliniumtetrakis(pentafluorophenyl)borate. After the three components are thoroughly mixed, a specified amount of the second co-catalyst, methylaluminoxane (MAO) in toluene is added; the mixture is diluted with toluene and stirred for ten minutes to give a homogeneous solution of the finished active catalyst.

In another embodiment, solutions of the active catalysts are prepared separately and blended in the desired ratios to achieve the desired poly-alpha-olefin custom blends. In some embodiments, if a toluene-free catalyst system is desired, an equivalent volume of dry inert medium such as mineral oil is added to the solution and the toluene removed under vacuum, leaving a suspension of the catalyst.

In an embodiment, PAO is made from alpha olefin monomers, such as 1-octene, 1-decene or dodecene. The feedstock of the monomers is not mixed and does not contain ethylene, propylene, butene, or pentene. In some embodiments, the PAO produced is a homopolymer (only one monomer used). In some other embodiments, the PAO produced is a copolymer.

In various embodiments, the polymerization process is a one-step process. In various embodiments, there is not a second oligomerization step and no oligomerization catalyst (e.g., a Lewis acid catalyst) is used. In various embodiments, there is no crystalline polymer or crystalline polymer segments made. In various embodiments, there is no functionalization of the PAO. In various embodiments, no solvent is used in the polymerization process.

In an embodiment, polymerization is carried out in the presence of a 5-component catalyst system (see Table 1 and Table 2), i.e., catalysts C1+C2 with co-catalysts CC1+CC2+CC3 or with co-catalysts CC1+CC2+CC4. In various embodiments, the metallocene catalyst is of racemic structure, not of meso structure. In various embodiments, there is no solid support for the activator/co-catalyst. In various embodiments, the catalyst is suspended in oil, or liquid PAO. In various embodiments, the catalyst is not pre-polymerized.

In the art, the catalyst is typically selected for making a PAO of a certain viscosity. The reaction conditions are changed to vary the PAO viscosity. In this process, two catalysts are used to make two viscosities of PAO without having to change reaction conditions. Furthermore, the catalyst and co-catalyst ratio is not varied. Rather, the ratio of the two catalysts is varied to change PAO viscosity.

In various embodiments, the polymer blend produced by the disclosed method has a wide range of Kinematic viscosities (Kv), for example, in the range of 6-1000 centistokes (cSt) at 100° C. In various embodiments, the range of Kv is determined by the reaction conditions or by the catalysts selected. This process is suitable for use with mixtures of metallocene catalysts or mixtures consisting of metallocenes and suitable Ziegler-Natta catalysts.

In some embodiments, the PAO produced is hydrogenated. In some embodiments, a portion of the polymerization product is recycled to the reactor. In such cases, the reactor is purged to maintain a suitable amount of saturated hydrocarbon in the reactor and to prevent the buildup of byproducts and contaminants.

TABLE 1

| | | CAS | |
|---|---|---|---|
| Catalysts | Name | Number | Supplier |
| C1 | 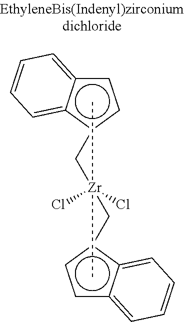 | 100080-82-8 | Chemtura |
| C2 | 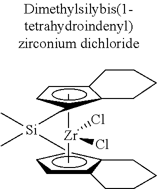 | 126642-97-5 | Chemtura |

TABLE 2

| Co- | | CAS | |
|---|---|---|---|
| catalysts | Name | Number | Supplier |
| CC1 | Methylaluminoxane (Al(CH₃)ₓO_{y})ₙ | 120144- | Chemtura |
| | or C₃H₉Al₃O₃X₂ Methyl-alumoxane | 90-3 | |
| CC2 | 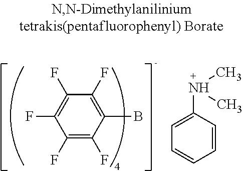 | 118612- 00-3 | Albemarle |
| CC3 | 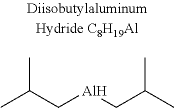 | 1191- 15-7 | Chemtura |
| CC4 | 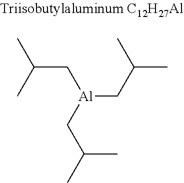 | 100-99- 2 | Chemtura |

Advantageous. The catalyst system and method of this disclosure have at least the following advantages: (1) providing a catalyst system for the production of custom blends of polyalphaolefins and/or polyolefin while eliminating the complex and time-consuming polymer blending process; (2) allowing production of low and high viscosity polyalphaolefins and polyolefins; (3) providing a process for producing polyalphaolefins and polyolefins having low levels of unsaturation (low bromine number); and (4) providing a process for production of copolymer (mixture of olefin monomers) oligomers and polymers.

### EXAMPLES

### Example 1

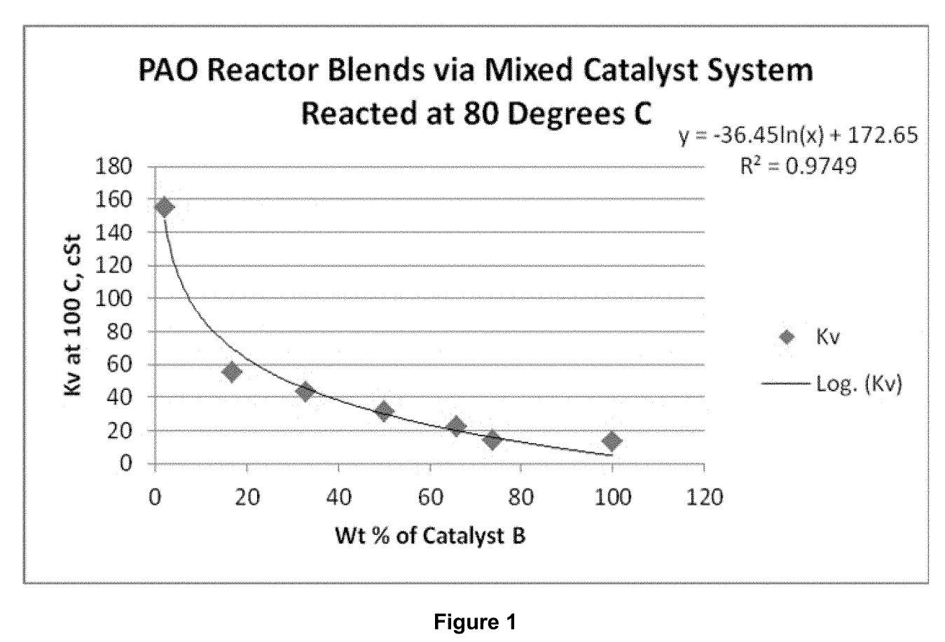

As shown in FIG. 1 and Table 3, a mixture of catalyst A (ethylene bis(indenyl) zirconium dichloride) and catalyst B (dimethylsilyl bis(1-tetrahydoindenyl) zirconium dichloride) was used to polymerize 1-decene at 80 degrees C. The product was isolated by diluting with hexane, washing with aqueous acid having pH of 3.5, and filtered through a 0.2 micron filter followed by removal of hexane and unreacted monomer under vacuum to produce a PAO blend having a wide range of Kinematic viscosities (Kv).

TABLE 3

| Catalyst A (wt %) | Catalyst B (wt %) | Kv (cSt) at 100° C. |
|---|---|---|
| 98.02 | 1.98 | 155 |
| 83.3 | 16.7 | 55 |
| 67 | 33 | 43 |
| 50 | 50 | 31 |
| 34 | 66 | 22 |
| 26.3 | 73.7 | 14 |
| 0 | 100 | 13.7 |

FIG. 1 shows the results of mixing two catalysts capable of producing PAO of various Kinematic viscosities (Kv). Under the conditions of the experiment, catalysts A and B have similar polymerization rates. Under these conditions catalyst A produces PAO with a Kv of approximately 170 centistokes (cSt); catalyst B produces PAO with a Kv of approximately 13 centistokes. Blending the catalysts in various ratios (weight or molar) results in production of polymer blends with various Kv values. Using the formulations, PAO with Kv ranging from 13 to 155 cSt can be produced. This allows production of custom blends. The range of blends can be determined by the two catalysts selected or by reaction conditions.

To get a different range of Kv, catalyst B can be combined with a catalyst capable of producing a Kv higher than catalyst A. In various cases, the produced PAO blend can have, but not limited to a Kv in the range of 10-170 cSt at 100° C.

### Example 2

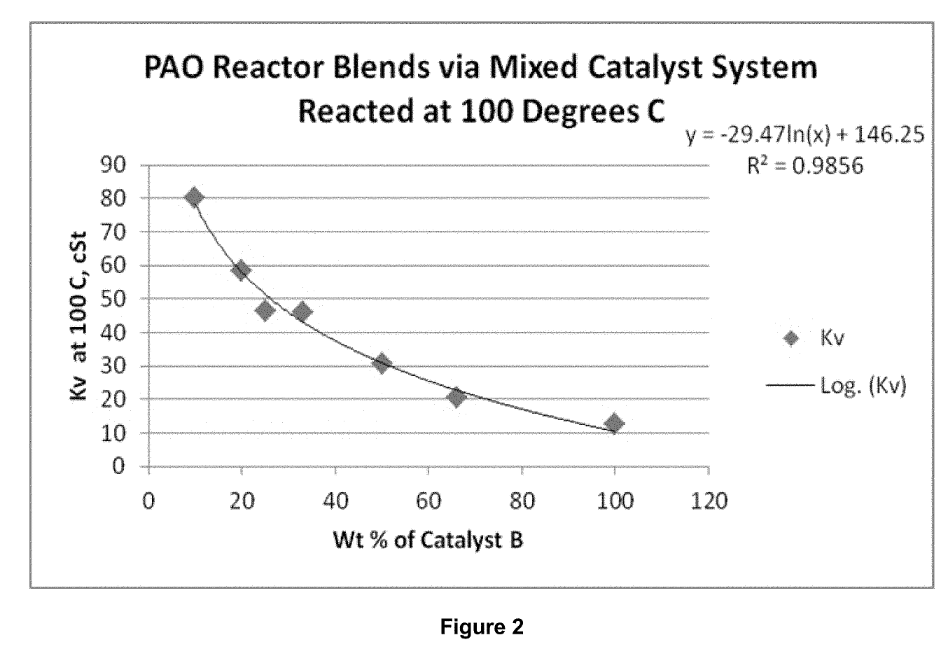

FIG. 2 and Table 4 show a mixture of two catalysts, with catalyst A being diphenylmethylene(cyclopentadienyl, 9-fluorenyl) zirconium dichloride and catalyst B is dimethylsilyl bis(1-tetrahydroindenyl) zirconium. Although catalyst A is capable of producing Kv greater than 500 cSt, when the mixture is reacted with 1-decene at 100 degrees C., PAO blends with Kv values ranging from 13 to approximately 120 cSt can be produced.

TABLE 4

| Catalyst A (wt %) | Catalyst B (wt %) | Kv (cSt) at 100° C. |
|---|---|---|
| 90 | 10 | 80 |
| 80 | 20 | 58.5 |
| 75 | 25 | 46.5 |
| 50 | 50 | 30.7 |
| 33.3 | 66.7 | 20.5 |
| 0 | 100 | 12.8 |

### Example 3

Table 5 shows the impact of reactor conditions on the range of blends produced with the mixed catalyst system. When catalysts A and B are reacted with 1-decene at 60 degrees C. and no hydrogen, PAO with Kv values of 245.2 and 22.5 cSt, respectively, are obtained. Mixing the two catalysts under these conditions will allow production of PAO ranging from 23 to 240 cSt. When the temperature is raised to 125 degrees C. with no hydrogen, catalysts A and B yield Kv values of 22.5 and 8.6 cSt respectively; mixing the two catalysts can produce PAO blends ranging from 8 to 23 cSt. When catalyst A is reacted with 1-decene in the presence of hydrogen at 60 degrees C., the Kv is reduced from 245.2 down to 131.9. When mixed with catalyst B, PAO blends with a maximum Kv of approximately 125 cSt can be expected.

TABLE 5

| Catalyst | Temperature, Deg C. | Hydrogen, psig | Kv (cSt) at 100° C. |
|---|---|---|---|
| A | 60 | 0 | 245.2 |
| B | 60 | 0 | 22.5 |
| A | 125 | 0 | 22.5 |
| B | 125 | 0 | 8.6 |
| A | 60 | 0 | 245 |
| A | 60 | 10 | 132 |

Catalyst A = Ethylene bis(indenyl) zirconium dichloride
Catalyst B = Dimethylsilyl bis(1-tetrahydroindenyl) zirconium dichloride

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent they provide exemplary, procedural or other details supplementary to those set forth herein.

What is claimed is:

1. A method of producing a poly-olefin blend comprising
providing a catalyst system comprising a first catalyst, a second catalyst, a first co-catalyst, a second co-catalyst, and a third co-catalyst;
polymerizing at least one monomer in a single step;
obtaining the poly-olefin blend having a Kinematic viscosity (Kv) of 6-1000 at 100 degrees C., wherein said Kv is adjusted by varying the ratio of the first catalyst to the second catalyst without mixing separately-synthesized polymers.

2. The method of claim 1, wherein said monomer does not contain ethylene, propylene, butene, or pentene.

3. The method of claim 1, wherein the produced poly-alpha-olefin is a homopolymer.

4. The method of claim 1, wherein the produced poly-alpha-olefin is a copolymer.

5. The method of claim 1, comprising no second oligomerization step and no use of oligomerization catalyst.

6. The method of claim 1, wherein no solvent is used in the polymerization step.

7. The method of claim 1, wherein said first catalyst comprises ethylenebis(indenyl) zirconium dichloride.

8. The method of claim 1, wherein said second catalyst comprises dimethylsilylbis(tetrahydro indenyl) zirconium dichloride.

9. The method of claim 1, wherein said first co-catalyst comprises N,N-dimethylaniliniumtetrakis(pentafluorophenyl) borate.

10. The method of claim 1, wherein said second co-catalyst comprises methylaluminoxane.

11. The method of claim 1, wherein said third co-catalyst comprises diisobutylaluminum hydride or triisobutylaluminum.

12. The method of claim 1, wherein the weight percentage of the first catalyst based on the total weight of the first and second catalysts is in the range of from 0 to 100 wt %.

13. The method of claim 1, wherein molar ratios of the first catalyst to each of the co-catalysts based on the active metal of the first catalyst are not varied.

14. The method of claim 1 comprising isolating the poly-olefin blend.

15. The method of claim 14 wherein said isolating comprises diluting with a solvent, washing with an acid, filtering, removing the solvent and unreacted monomer under vacuum, or combinations thereof.

16. A catalyst system comprising a first catalyst, a second catalyst, a first co-catalyst, a second co-catalyst, and a third co-catalyst, wherein molar ratios of the first catalyst to each of the co-catalysts based on the active metal of the first catalyst are not varied.

17. The catalyst system of claim 16, wherein said first catalyst comprises ethylenebis(Indenyl) zirconium dichloride.

18. The catalyst system of claim 16, wherein said second catalyst comprises dimethylsilylbis(tetrahydro indenyl) zirconium dichloride.

19. The catalyst system of claim 16, wherein said first co-catalyst comprises N,N-dimethylaniliniumtetrakis(pentafluorophenyl) borate.

20. The catalyst system of claim 16, wherein said second co-catalyst comprises methylaluminoxane.

21. The catalyst system of claim 16, wherein said third co-catalyst comprises diisobutylaluminum hydride or triisobutylaluminum.

22. The catalyst system of claim 16 capable of producing a custom poly-alpha-olefin blend in a single polymerization step, wherein said custom poly-alpha-olefin blend has a Kinematic viscosity (Kv) adjusted by varying the ratio of the first catalyst to the second catalyst without mixing separately-synthesized polymers.

23. The catalyst system of claim 16, wherein the weight percentage of the first catalyst based on the total weight of the first and second catalysts is in the range of from 0 to 100 wt %.

24. The catalyst system of claim 16 comprising a metallocene catalyst of racemic structure, not of meso structure.

25. The catalyst system of claim 16 comprising no solid support for the co-catalysts.
